(19) United States
(12) Patent Application Publication
(10) Pub. No.: US 2025/0166898 A1
(43) Pub. Date: May 22, 2025

(54) CAPACITOR AND METHOD OF MANUFACTURING THEREOF

(71) Applicant: NANYA TECHNOLOGY CORPORATION, New Taipei city (TW)

(72) Inventors: Chih-Chun HSIAO, Taipei City (TW); Ji-Feng LIU, New Taipei City (TW)

(21) Appl. No.: 18/515,291

(22) Filed: Nov. 21, 2023

(51) Int. Cl. H01G 4/008; H01G 4/12; H01G 4/38

(52) U.S. Cl. CPC H01G 4/008; H01G 4/1209; H01G 4/38

(57) ABSTRACT

A method of manufacturing a capacitor includes forming a bottom electrode layer; forming an insulator on the bottom electrode layer; crystallizing the insulator; and forming a top electrode layer on the crystallized insulator. As such, the leakage problem due to thinner top electrode layer and smaller critical dimension of the capacitor can be reduced. In addition, possibility for the capacitors to collapse is reduced, and the electrical performance of the capacitor won't be affected by the collapse problem.

### BACKGROUND

### Field of Invention

The present invention relates to a capacitor and a method of manufacturing a capacitor.

### Description of Related Art

Semiconductor devices are widely used in electronics industries. The critical dimension of the capacitor shrinks and the thickness of each layers forming the capacitor become thinner. As a result, leakage problem due to thinner electrode, collapse problem due to insufficient mechanical strength, and reduction of capacitance may occur.

Accordingly, it is still a development direction for the industry to provide a capacitor and a method of forming the capacitor which can solve those problems.

### SUMMARY

One aspect of the present disclosure provides a method of manufacturing a capacitor.

The method of manufacturing a capacitor includes forming a bottom electrode layer; forming an insulator on the bottom electrode layer; crystallizing the insulator; and forming a top electrode layer on the crystallized insulator.

In one embodiment, the step of crystallizing the insulator is performed through an anneal treatment.

In one embodiment, the step of crystallizing the insulator is performed before the step of forming the top electrode layer.

In one embodiment, the method of manufacturing the capacitor further includes forming an oxide diffusion barrier layer between the insulator and the top electrode layer.

In one embodiment, the oxide diffusion barrier layer includes titanium oxynitride.

In one embodiment, the bottom electrode layer includes titanium silicon nitride.

In one embodiment, a temperature of the step of crystallizing the insulator is in a range from 400 degrees to 600 degrees.

In one embodiment, a time period of the step of crystallizing the insulator is in a range from 30 seconds to 100 seconds.

In one embodiment, a time period of the step of crystallizing the insulator is shorter than a time period of the step of forming the top electrode layer.

Another aspect of the present disclosure provides a method of manufacturing a capacitor.

In one embodiment, the method of manufacturing a capacitor includes forming a bottom electrode layer; forming an insulator on the bottom electrode layer; forming a titanium oxynitride layer on the insulator; and forming a top electrode layer on the insulator.

In one embodiment, the method of manufacturing a capacitor further includes performing an anneal treatment to the insulator.

In one embodiment, the anneal treatment is performed before forming the top electrode layer.

In one embodiment, a temperature of the step of performing the anneal treatment is in a range from 400 degrees to 600 degrees.

In one embodiment, a time period of the step of performing the anneal treatment is in a range from 30 seconds to 100 seconds.

Another aspect of the present disclosure provides a capacitor.

In one embodiment, the capacitor includes a bottom electrode layer, an insulator disposed on the bottom electrode layer, an oxide diffusion barrier layer disposed on the insulator, and a top electrode layer disposed on the oxide diffusion barrier layer.

In one embodiment, the top electrode layer includes titanium nitride, and the oxide diffusion barrier layer comprises titanium oxynitride.

In one embodiment, the bottom electrode layer includes titanium silicon nitride.

In one embodiment, a material of the bottom electrode layer is different form a material of the top electrode layer.

In one embodiment, the bottom electrode layer has higher mechanical strength than the top electrode layer.

In one embodiment, an oxygen concentration of the oxide diffusion barrier layer is higher than the top electrode layer.

In the aforementioned embodiments, an oxide diffusion barrier layer including titanium oxynitride is disposed between the top electrode layer and the insulator. The concentration of oxygen in the oxide diffusion barrier layer is much higher than the top electrode layer, and therefore it is difficult for the oxide atoms in the oxide diffusion barrier layer to diffuse towards the top electrode layer. As such, the leakage problem due to thinner top electrode layer and smaller critical dimension of the capacitor can be reduced. In addition, the bottom electrode layer includes titanium silicon nitride, which has higher mechanical strength. Therefore, possibility for the capacitors to collapse is reduced, and the electrical performance of the capacitor won't be affected by the collapse problem. In addition, the step of crystallizing the insulator is performed before the step of forming the top electrode layer. A temperature of the step of crystallizing the insulator is in a range from 400 degrees to 600 degrees. A time period of the step of crystallizing the insulator 154 is in a range from 30 seconds to 100 seconds, which is shorter than a time period of the step of forming the top electrode layer. Therefore, fewer byproducts are formed in the process, the capacitance is increased, and the electrical performance of the insulator can be improved.

### BRIEF DESCRIPTION OF THE DRAWINGS

The invention can be more fully understood by reading the following detailed description of the embodiment, with reference made to the accompanying drawings as follows:

FIG. 1 is a cross sectional view of a capacitor array structure.

FIG. 2 is a partial view of the capacitor array structure in FIG. 1.

FIG. 3 is a flow chart of a method of manufacturing the capacitor.

FIG. 4 is a cross sectional view of the capacitor in the intermediate of the manufacturing method.

FIG. 5 is a cross sectional view of the capacitor in the intermediate of the manufacturing method.

FIG. 6 is a cross sectional view of the capacitor in the intermediate of the manufacturing method.

FIG. 7 is a cross sectional view of the capacitor in the intermediate of the manufacturing method.

FIG. 8 is a cross sectional view of the capacitor in the intermediate of the manufacturing method.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

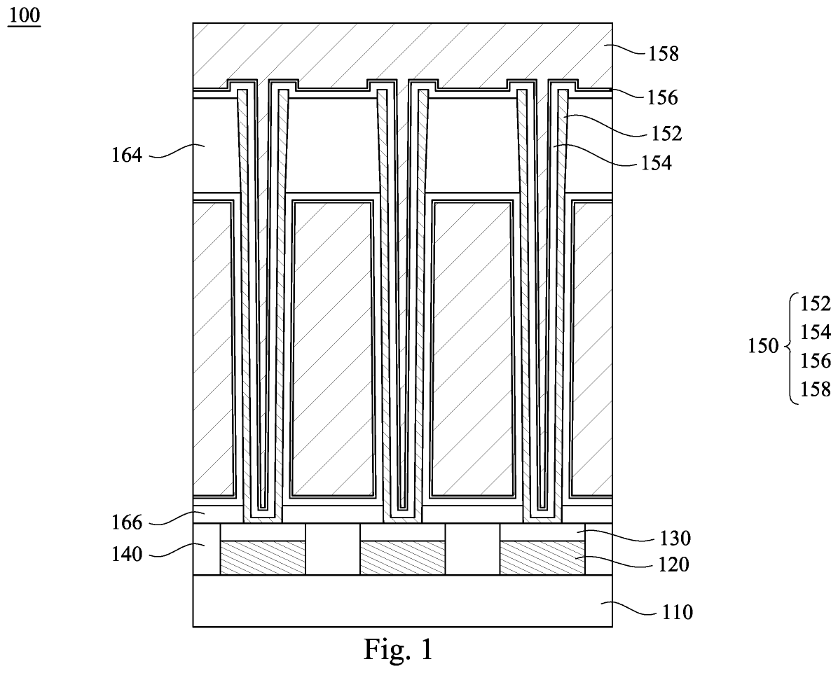

FIG. 1 is a cross sectional view of a capacitor array structure 100. The capacitor array structure 100 includes a substrate 110, a capacitor contact 120, a metal layer 130, a dielectric layer 140, and a capacitor 150.

The substrate 110 may include Silicon (Si), Germanium (Ge), Silicon-germanium (SiGe), silicon carbide (SiC), SiGeC, gallium (Ga), gallium arsenide (GaAs), indium arsenide (InAs), Indium phosphide (InP), silicon germanium-on-insulator, or silicon-on-insulator. The substrate 110 includes insulation structure, active region, and transistors (not shown) formed in the active region.

The capacitor contact 120 is disposed on the substrate 110 and is electrically connected with the transistors therein. The metal layer 130 is used as a conductive pad disposed on the capacitor contact 120. The capacitor contact 120 is electrically connected with the capacitor 150 through the metal layer 130. In some embodiments, the material of the capacitor contact 120 and the metal layer 130 include poly-silicon, Titanian (Ti), Titanian nitride (TiN), Tantalum (Ta), TaN, tungsten (W), copper (Cu), Aluminum (AI), or alloy thereof.

The dielectric layer 140 surrounds the capacitor contact 120 and the metal layer 130. The material of the dielectric layer 140 may include silicon dioxide (SiO₂), silicon nitride (Si₃N₄), Undoped silicate glass (USG), boro silicate glass (BSG), phosphor silicate glass (PSG), Borophosphosilicate glass (BPSG), Tetraethhoxysilane (TEOS), Fluorosilicate Glass (FSG), PI, or combination thereof.

The capacitor 150 includes a bottom electrode layer 152, an insulator 154 disposed on the bottom electrode layer 152, an oxide diffusion barrier layer 156 disposed on the insulator 154, and a top electrode layer 158 is disposed on the oxide diffusion barrier layer 156.

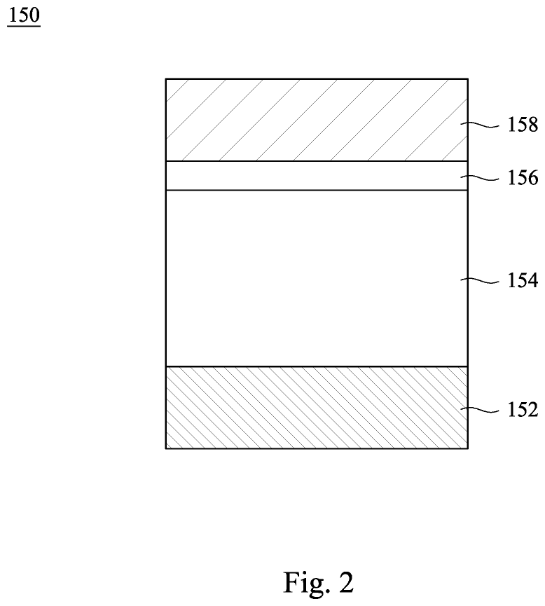

FIG. 2 is a partial view of the capacitor array structure in FIG. 1. As the critical dimension of the capacitor 150 shrinks and the thickness of each layers become thinner, possibility of tunneling effect increases. The insulator 154 is a high-k dielectric material layer and may include Aluminium hydroxide (Al₂O₃), hafnium oxide (HfO₂), hafnium oxynitride (HfON), hafnium silicate (HfSiO₄, zirconium oxide (ZrO₂), zirconium oxynitride (ZrON), zirconium silicate (ZrSiO₂), yttrium oxide (Y₂O₃), lanthanum oxide (La₂O₃), cerium oxide (CeO₂), titanium oxide (TiO₂), tantalum oxide (Ta₂O₅), or combination thereof. In the present embodiment, the insulator 154 is a composite layer formed by an Aluminium hydroxide (Al₂O₃) layer sandwiched by two Zirconium dioxide (ZrO₂) layers. As a result, oxide atoms diffuse from the insulator 154 to the top electrode layer 158 when forming the top electrode layer 158 on the insulator 154 in a conventional method. Therefore, leakage problem occurs due to the thinner top electrode layer 158 and the diffused oxygen atoms.

In the present embodiment, the top electrode layer 158 includes titanium nitride (TiN) and the oxide diffusion barrier layer 156 includes titanium oxynitride (TiON). Since the concentration of oxygen in the oxide diffusion barrier layer 156 (i.e., TiON layer) is much higher than the top electrode layer 158, it is difficult for the oxide atoms in the oxide diffusion barrier layer 156 to diffuse towards the top electrode layer 158. Therefore, the leakage problem due to thinner top electrode layer 158 and smaller critical dimension of the capacitor 150 can be reduced.

As shown in FIG. 1 and FIG. 2. As the critical dimension of the capacitor 150 shrinks and the thickness of each layers become thinner, the aspect ratio of the trench capacitor as shown in FIG. 1 is much higher. In such embodiments, the structure supporting strength mainly provided by the bottom electrode layer 152. Therefore, the capacitor 150 may collapse more easily and the possibility for two adjacent capacitors to contact with each other is higher due to thinner bottom electrode layer 152.

In the present embodiment, the bottom electrode layer 152 includes titanium silicon nitride (TiSiN), which is a silicon doped titanium nitride. In other words, a material of the bottom electrode layer 152 is different form a material of the top electrode layer 158. The titanium silicon nitride has higher mechanical strength. Therefore, possibility for the capacitors to collapse is reduced, and the electrical performance of the capacitor 150 won't be affected by the collapse problem.

It is to be noted that the connection relationships, materials, and advantages of the elements described above will not be repeated. In the following description, a manufacturing method of the capacitor 150 will be described.

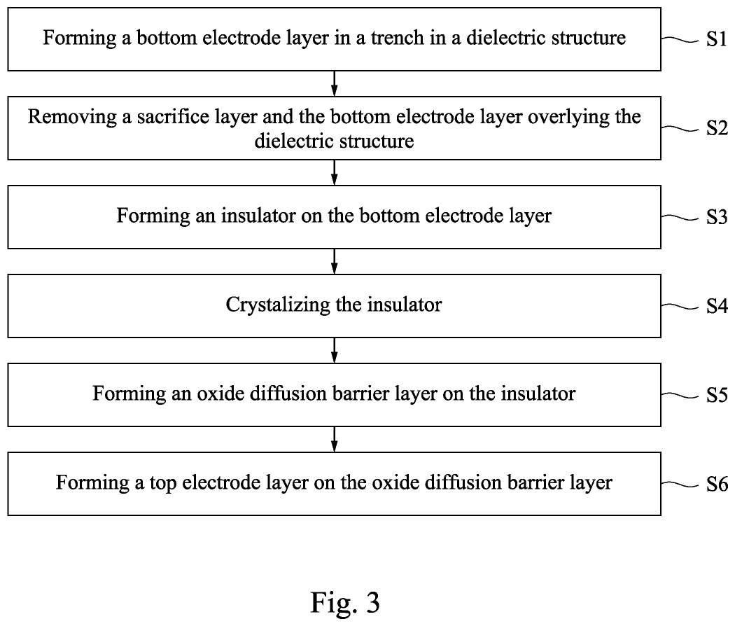

FIG. 3 is a flow chart of a method of manufacturing the capacitor 150 in FIG. 1. The method begins at step S1, which is forming a bottom electrode layer in a trench in a dielectric structure. The method continues to step S2, which is removing a sacrifice layer and the bottom electrode layer overlying the dielectric structure. The method continues to step S3, which is forming an insulator on the bottom electrode layer. The method continues to step S4, which is crystalizing the insulator. The method continues to step S5, which is forming an oxide diffusion barrier layer on the insulator. Lastly, in step S6, forming a top electrode layer on the oxide diffusion barrier layer.

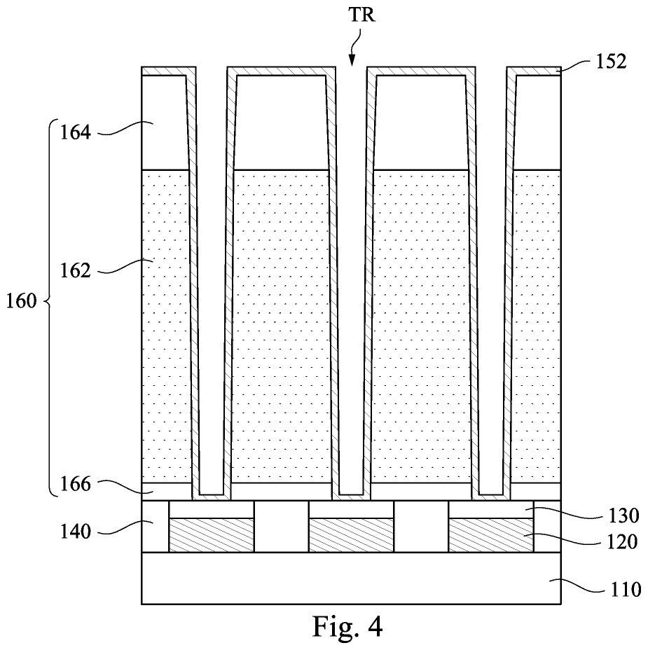

FIG. 4 is a cross sectional view of the capacitor in the intermediate of the manufacturing method. Reference is made to FIG. 3 and FIG. 4. In step S1, the bottom electrode layer 152 is formed in a trench TR formed in a dielectric structure 160. The bottom electrode layer 152 can be formed through plating process, printing process, chemical vapor deposition (CVD), physical vapor deposition (PVD), atomic layer deposition (ALD), or other suitable process, but the present disclosure is not limited thereto.

The dielectric structure 160 is formed above the substrate 110, the capacitor contact 120 and the metal layer 130. The metal layer 130 is exposed form the trench TR, and the bottom electrode layer 152 contacts the metal layer 130.

In the present embodiment, the dielectric structure 160 includes a sacrifice layer 162, a supporting layer 164, and an etching stop layer 166, but the present disclosure is not limited thereto. In some other embodiments, the dielectric structures may include stacked sacrifice layers and supporting layers. The sacrifice layer 162 may be an oxide layer such as TEOS, and the supporting layer 164 may be a nitride layer, but the present disclosure is not limited thereto.

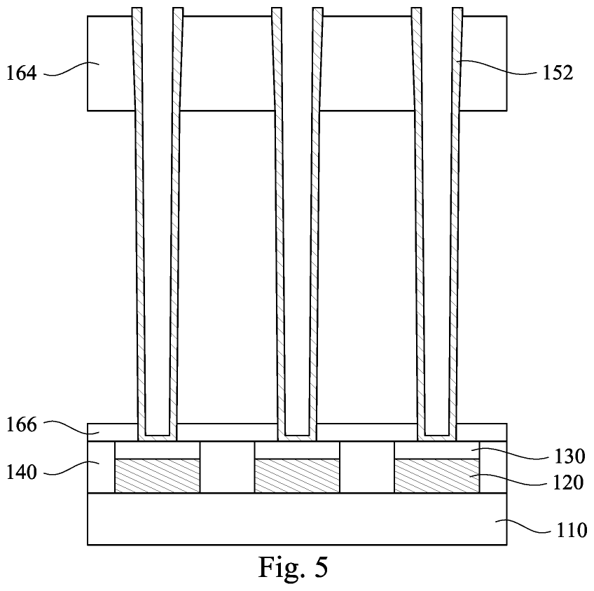

FIG. 5 is a cross sectional view of the capacitor in the intermediate of the manufacturing method. Reference is made to FIG. 3 and FIG. 5. In step S2, the sacrifice layer 162 and the bottom electrode layer 152 overlying the dielectric structure 160 are removed through an etching process such as wet etch. It is noted that, this step may be omitted or exchanged with other steps depends on the actual structures of the dielectric structure 160.

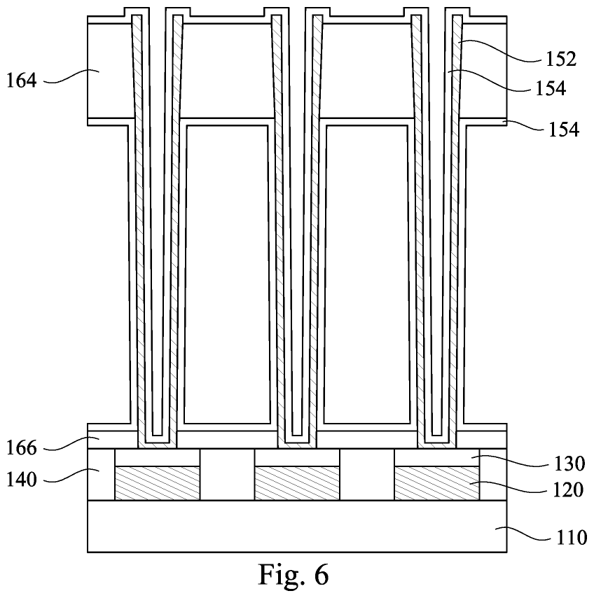

FIG. 6 is a cross sectional view of the capacitor in the intermediate of the manufacturing method. Reference is made to FIG. 3 and FIG. 6. In step S3, the insulator 154 is formed on the bottom electrode layer 152. In the present embodiment, since the capacitor 150 is a double-sided capacitor, the insulator 154 warps the bottom electrode layer 152 and the supporting layer 164 and covers the etching stop layer 166. In some other embodiments, the capacitor may be a single-sided capacitor, and the insulator 154 at least covers the bottom electrode layer 152. The insulator 154 can be formed through plating process, printing process, chemical vapor deposition (CVD), physical vapor deposition (PVD), atomic layer deposition (ALD), or other suitable process, but the present disclosure is not limited thereto.

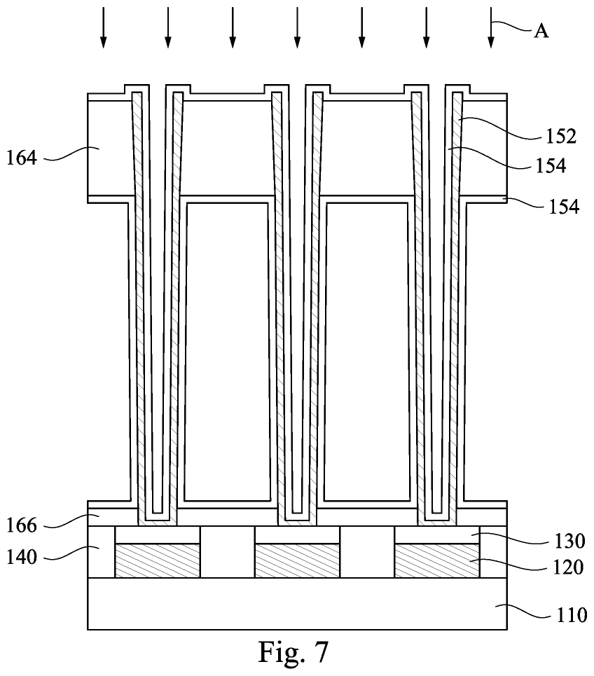

FIG. 7 is a cross sectional view of the capacitor in the intermediate of the manufacturing method. Reference is made to FIG. 3 and FIG. 7. In step S4, crystalizing the insulator 154. In the present embodiment, the step of crystallizing the insulator 154 is performed through an anneal treatment A. As such, capacitance of the capacitor 150 can be increased.

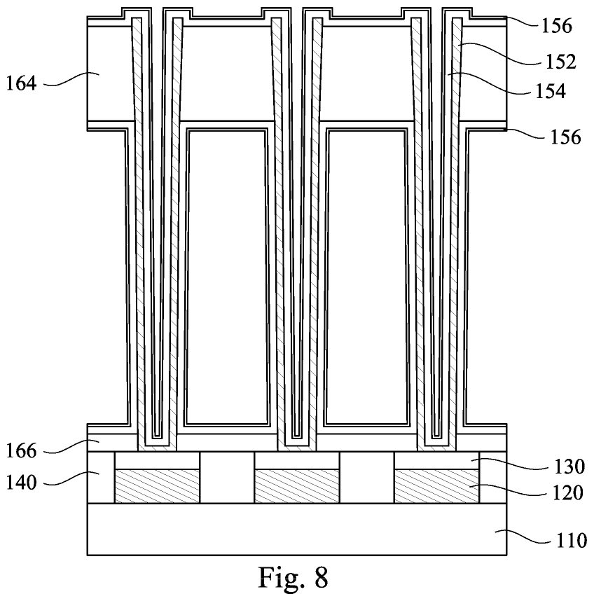

FIG. 8 is a cross sectional view of the capacitor in the intermediate of the manufacturing method. Reference is made to FIG. 3 and FIG. 8. In step S5, the oxide diffusion barrier layer 156 is formed on the insulator 154. Specifically, oxide diffusion barrier layer 156 is conformally formed on the insulator 154. The oxide diffusion barrier layer 156 is a titanium oxynitride layer. The titanium oxynitride layer can be formed through chemical vapor deposition (CVD), physical vapor deposition (PVD), atomic layer deposition (ALD), or other suitable process, but the present disclosure is not limited thereto.

Reference is made to FIG. 3 and FIG. 1. In step S6, forming the top electrode layer 158 on the oxide diffusion barrier layer 156. As shown in FIGS. 7-8 and FIG. 1 corresponding to steps S4-S6, the step of crystallizing the insulator 154 is performed before the step of forming the top electrode layer 158. As the critical dimension of the capacitor 150 shrinks and the thickness of each layers become thinner, the capacitance of the capacitor 150 may reduce. In a conventional method, the insulator 154 is crystalized during the step of forming the top electrode layer 158 to increase the capacitance. However, in such method, byproducts are produced in the capacitor which affects the electrical performance thereof.

For example, in the conventional method, a temperature of the step of crystallizing the insulator when forming the top electrode layer is in a range from 400 degrees to 500 degrees, and a time period of this step is in a range from 300 seconds to 350 seconds. In step S4 of the present embodiment, a temperature of the step of crystallizing the insulator 154 is in a range from 400 degrees to 600 degrees. A time period of the step of crystallizing the insulator 154 is in a range from 30 seconds to 100 seconds. Therefore, a time period of the step of crystallizing the insulator 154 is shorter than a time period of the step of forming the top electrode layer 158. Since the time period of the step S4 is much shorter than the time period of step S5, fewer byproducts are formed in the process. Therefore, the capacitance is increased and the electrical performance of the insulator can be improved.

In summary, an oxide diffusion barrier layer including titanium oxynitride is disposed between the top electrode layer and the insulator. The concentration of oxygen in the oxide diffusion barrier layer is much higher than the top electrode layer, and therefore it is difficult for the oxide atoms in the oxide diffusion barrier layer to diffuse towards the top electrode layer. As such, the leakage problem due to thinner top electrode layer and smaller critical dimension of the capacitor can be reduced. In addition, the bottom electrode layer includes titanium silicon nitride, which has higher mechanical strength. Therefore, possibility for the capacitors to collapse is reduced, and the electrical performance of the capacitor won't be affected by the collapse problem. In addition, the step of crystallizing the insulator is performed before the step of forming the top electrode layer. A temperature of the step of crystallizing the insulator is in a range from 400 degrees to 600 degrees. A time period of the step of crystallizing the insulator 154 is in a range from 30 seconds to 100 seconds, which is shorter than a time period of the step of forming the top electrode layer. Therefore, fewer byproducts are formed in the process, and the electrical performance of the insulator can be improved.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method of manufacturing a capacitor, comprising:
forming a bottom electrode layer;
forming an insulator on the bottom electrode layer;
crystallizing the insulator; and
forming a top electrode layer on the crystallized insulator.

2. The method of manufacturing the capacitor of claim 1, wherein the step of crystallizing the insulator is performed through an anneal treatment.

3. The method of manufacturing the capacitor of claim 1, wherein the step of crystallizing the insulator is performed before the step of forming the top electrode layer.

4. The method of manufacturing the capacitor of claim 1, further comprising:
forming an oxide diffusion barrier layer between the insulator and the top electrode layer.

5. The method of manufacturing the capacitor of claim 4, wherein the oxide diffusion barrier layer comprises titanium oxynitride.

6. The method of manufacturing the capacitor of claim 1, wherein the bottom electrode layer comprises titanium silicon nitride.

7. The method of manufacturing the capacitor of claim 1, wherein a temperature of the step of crystallizing the insulator is in a range from 400 degrees to 600 degrees.

8. The method of manufacturing the capacitor of claim 1, wherein a time period of the step of crystallizing the insulator is in a range from 30 seconds to 100 seconds.

9. The method of manufacturing the capacitor of claim 1, wherein a time period of the step of crystallizing the insulator is shorter than a time period of the step of forming the top electrode layer.

10. A method of manufacturing a capacitor, comprising:
forming a bottom electrode layer;
forming an insulator on the bottom electrode layer;
forming a titanium oxynitride layer on the insulator; and
forming a top electrode layer on the insulator.

11. The method of manufacturing the capacitor of claim 10, further comprising:
performing an anneal treatment to the insulator.

12. The method of manufacturing the capacitor of claim 11, wherein the anneal treatment is performed before forming the top electrode layer.

13. The method of manufacturing the capacitor of claim 11, wherein a temperature of the step of performing the anneal treatment is in a range from 400 degrees to 600 degrees.

14. The method of manufacturing the capacitor of claim 11, wherein a time period of the step of performing the anneal treatment is in a range from 30 seconds to 100 seconds.

15. A capacitor, comprising:
a bottom electrode layer;
an insulator disposed on the bottom electrode layer;
an oxide diffusion barrier layer disposed on the insulator; and
a top electrode layer disposed on the oxide diffusion barrier layer.

16. The capacitor of claim 15, wherein the top electrode layer comprises titanium nitride, and the oxide diffusion barrier layer comprises titanium oxynitride.

17. The capacitor of claim 15, wherein the bottom electrode layer comprises titanium silicon nitride.

18. The capacitor of claim 15, wherein a material of the bottom electrode layer is different form a material of the top electrode layer.

19. The capacitor of claim 15, wherein the bottom electrode layer has higher mechanical strength than the top electrode layer.

20. The capacitor of claim 15, wherein an oxygen concentration of the oxide diffusion barrier layer is higher than the top electrode layer.
